(19) United States
(12) Patent Application Publication
(10) Pub. No.: US 2026/0218548 A1
(43) Pub. Date: Jul. 30, 2026

(54) Method for controlling a flush door handle of a motor vehicle

(71) Applicant: SCHAEFFLER TECHNOLOGIES AG & CO. KG, Herzogenaurach (DE)

(72) Inventors: Ihssen MASRI, Angouleme (FR); Cyril ROBIN, Goyrans (FR); Vincent DINH, Toulouse (FR)

(73) Assignee: SCHAEFFLER TECHNOLOGIES AG & CO, KG, Herzogenaurach (DE)

(21) Appl. No.: 19/140,617

(22) PCT Filed: Jan. 19, 2024
(86) PCT No.: PCT/EP2024/051270

§ 371 Date: Jun. 18, 2025

(30) Foreign Application Priority Data
Jan. 24, 2023 (FR) FR2300642

(51) Int. Cl. E05B 85/10; B60R 25/01; B60R 25/31; E05B 81/56; E05B 81/78; G01S 13/50; G01S 13/88

(52) U.S. Cl. CPC E05B 85/107; E05B 81/56; E05B 81/78; G01S 13/50; G01S 13/88; B60R 25/01; B60R 25/31

(57) ABSTRACT

A system for controlling the toggling of a flush door handle of a motor vehicle from a rest position to a gripping position. The system including: a detection unit configured to transmit a radio-frequency signal, and to receive a return signal resulting from reflection of the transmitted signal by a target; and a control unit configured to perform gesture detection using the data from the detection unit, to generate an instruction to toggle from one position to another when a gesture indicating an access intention of a user is detected, and to transmit the instruction to a motor unit configured to control a position of the flush door handle.

### CROSS-REFERENCE TO RELATED APPLICATIONS

This application is the U.S. National Phase Application of PCT International Application No. PCT/EP 2024/051270, filed Jan. 19, 2024, which claims priority to French Patent Application No. FR 2300642, filed Jan. 24, 2023, the contents of such applications being incorporated by reference herein.

### FIELD OF THE INVENTION

The invention relates to the field of motor vehicles and more particularly to a system intended to be integrated into a flush door handle of a motor vehicle in order to control a position of said handle.

### BACKGROUND OF THE INVENTION

Nowadays, motorized flush door handles are increasingly popular in the automotive field.

A flush door handle is a door handle capable of assuming, during use, at least two of the following positions:
a rest position, in which it is flush with the outer surface of the door, and
a gripping position, in which at least part of the handle is arranged offset in relation to the outer surface of the door, thus providing a grip for the user.

“Flush with the outer surface of the door” means a topological jump of negligible area, for example less than 3 mm, at the transition between the handle and the outer surface of the door and without considering the gap between the two.

In the gripping position, at least part of the handle protrudes in relation to the outer surface of the door toward the outside of the vehicle. In other words, the handle deploys toward the outside of the vehicle.

Alternatively, in the gripping position, at least part of the handle is arranged indrawn inside a housing formed in the door, thus freeing access to the housing for the user's hand. In other words, the handle withdraws toward the inside of the vehicle.

Such a handle is brought from a position by way of a motor unit that comprises an electric motor and its control system.

Such a door handle is shown schematically in FIGS. 1A and 1B. In the example illustrated in FIGS. 1A and 1B, the handle deploys toward the outside of the vehicle, into the gripping position.

In FIG. 1A, the handle 10 is shown in the rest position. It is housed inside the housing 11 formed in the door 20 and is flush with the outer surface 21 of the door.

In FIG. 1B, it is shown in the gripping position, with a gripping portion 12 situated outside the housing 11, and a deployment portion 13 taking up a deployed position and extending between the door 20 and said gripping portion 12.

The control system can comprise:
a contact sensor configured to detect direct physical contact between a user's hand and the handle; and
a control unit configured to control the rest or gripping position of the handle according to data supplied by the contact sensor.

A disadvantage of this solution is that it requires the user to touch the handle while the handle is simply flush with the surface of the door, without being able to be gripped, and the user must then wait for the handle to toggle into its gripping position before being able to grasp it and open the door. There is therefore a string of gestures that is not fluid, and there are waiting times that can be uncomfortable for the user.

One solution for overcoming these disadvantages is to use user badge recognition. During use, the user wears a badge equipped with a radio-frequency device, for example of UWB type, capable of communicating with a badge reader situated in the door handle. When the presence of the badge is detected close to the vehicle, a control unit controls the toggling of the handle into its gripping position.

However, a disadvantage is the risk of untimely toggling of the position of the handle as soon as the user enters a wide perimeter around the vehicle. In other words, from the moment the user wears the badge, the handle is placed into the gripping position whenever they are close to the vehicle, even if their actual intention is not to access the vehicle.

It is therefore an aim of the invention to propose a solution for overcoming the aforementioned disadvantages.

In particular, it is an aim of this invention to propose a system for controlling the toggling of a flush door handle of a motor vehicle, from its rest position to its gripping position, the method providing optimized ease of use while avoiding untimely position toggling, which is not desired by the user.

### SUMMARY OF THE INVENTION

This aim is achieved with a system for controlling a flush handle mounted, during use, on a motor vehicle door, the system comprising:
a detection unit; and
a control unit comprising at least one memory and at least one processor, configured to receive data from the detection unit, to analyze these data and generate an instruction to toggle from a rest position to a gripping position of the handle when an intention of a user to access the vehicle is detected, and to transmit said instruction to a motor unit configured to control a position of the flush handle.

The rest position of said handle denotes the position in which, when installed on the door of the vehicle, during use, it is flush with the outer surface of the door.

The gripping position of said handle denotes the position in which, when installed on the door of the vehicle, during use, it directly or indirectly (by freeing access to a cavity) provides a grip for the user's hand.

According to an aspect of the invention, the system has the following specific features:
the detection unit is configured to transmit a signal called the “transmitted signal”, of radio-frequency type, and to receive a return signal resulting from reflection of the transmitted signal by a target; and
the control unit is configured to perform a gesture detection using the data from the detection unit, detection of a gesture indicating the intention to access the vehicle.

In other words, the position of the handle is controlled using a gesture detection, the gesture indicating an access intention of a user.

The access intention is therefore detected well before the user touches the handle. The instruction to toggle the position of the handle can thus be sent well before the user touches the handle, and so that the handle is in the gripping position (or at least in an intermediate position between the rest position and the gripping position) when the user's hand comes into contact therewith. Thus, it is possible to reduce, or even eliminate, a latency separating the first physical contact between the user's hand and the door and the moment when the handle is in the gripping position and capable of being grasped by the user to access the vehicle. In particular, said latency can be cancelled out when a user authentication has been carried out upstream, by way of a radio-frequency communication with a user badge (UWB or BLE communication, for example). Ease of use is therefore improved in comparison with the prior art based on a contact sensor or an immediate proximity sensor (of the order of one centimeter).

Throughout this text, the term “radio-frequency” relates to a signal whose carrier frequency is between 3 kHz and 300 GHz. Preferably, the carrier frequency is, in an aspect of the invention, between 5 GHz and 20 GHz, and more preferably between 5 GHz and 10 GHz.

The radio-frequency signal is advantageously a pulsed signal, wherein the pulses are carried by a carrier at a radio-frequency frequency as defined above. Advantageously, the carrier frequency is fixed. In variants, the carrier frequency varies as a function of time within each pulse.

Alternatively, it may be a continuous signal, for example a frequency modulated continuous wave, or FMCW, signal. It is a continuous signal whose frequency varies as a function of time, so that it can sweep a wide frequency range.

Advantageously, the gesture indicating an access intention is not a complex gesture. In particular, it is not a gesture involving one or more changes of direction. Advantageously, the gesture indicating an access intention is simply the gesture by which the user moves their hand toward the detection unit to take hold of the handle. Thus, gesture detection does not require performance of complex algorithms in order to recognize a specific gesture. It can simply be a matter of detecting any movement, or simply a movement taking the target toward the detection unit.

Preferably, the detection unit is configured to transmit a transmitted signal for which a ratio of the bandwidth divided by the center frequency is greater than or equal to 20%, and/or whose spectral width is greater than or equal to 500 MHz. In other words, the transmitted signal is an ultra-wideband, or UWB, signal. Alternatively, it may be a frequency modulated continuous wave signal, wherein the frequency variation sweeps a spectral band satisfying those same conditions. The use of a wideband signal makes it possible to extract a portion of the return signal that is associated with a desired distance interval between the target and the system according to an aspect of the invention.

Advantageously, the detection unit is configured to transmit a transmitted signal of pulsed type for which a ratio of the bandwidth divided by the center frequency is greater than or equal to 20% and/or whose spectral width is greater than or equal to 500 MHz, and the detection unit and the control unit are configured together to:
a/ generate sampled data relating to the return signal; and
b/ for each of a plurality of successive time intervals ΔTⱼ, extract sampled data situated in said time interval ΔTⱼ, and relating to sampling times for which the time difference between transmission of a pulse of the pulsed transmitted signal and reception of a corresponding pulse of the pulsed return signal is lower than a first predetermined threshold.

Step b/ corresponds to an extraction of data relating to detection of a target situated at a distance from the system that is less than a predetermined threshold distance.

Advantageously, the detection unit and the control unit are configured together to then perform the following steps:
c/ for each of said successive time intervals, and using the values extracted in step b/, computing a phase shift value of a phase shift between the return signal and the transmitted signal; then
d/ using the phase shift values to detect a gesture.

Said first predetermined threshold advantageously corresponds to a distance d_1 between the detection unit and the target of between 150 cm and 5 cm, preferably between 40 cm and 5 cm.

Preferably, step b/ carries out an extraction of the sampled data relating to sampling times for which the time difference between transmission of a pulse of the transmitted signal and reception of a corresponding pulse of the return signal is lower than a first predetermined threshold and higher than a second predetermined, non-zero threshold.

The control unit can moreover be connected to an unlocking module for unlocking the door receiving the flush handle, and the control unit is configured to generate an unlock instruction and to transmit said instruction to the unlocking module.

The control unit can be configured to transmit the unlock instruction after a predetermined time interval following transmission of the instruction to toggle from the rest position to the gripping position, the time interval possibly being zero.

Alternatively, the system according to an aspect of the invention moreover comprises a presence sensor configured to detect a presence in close proximity, and the control unit is configured to transmit the unlock instruction according to data supplied by the presence sensor.

Advantageously, the control unit is moreover capable of generating an instruction to toggle from the gripping position to the rest position, and of transmitting said instruction to the motor unit controlling the position of the flush handle.

The system according to an aspect of the invention can moreover comprise a pinch detection unit capable of detecting the presence of an obstacle blocking toggling of the flush handle from one position to the other and of communicating this information to the control unit, and the control unit is configured to respond by generating and transmitting to the motor unit controlling the position of the flush handle an instruction intended to pause and/or reverse toggling of the flush handle from one position to the other.

The system according to an aspect of the invention can moreover comprise:
a warning means configured to transmit a luminous and/or audible warning signal; and
a unit for controlling the warning means, connected to the control unit and configured to control transmission of a luminous and/or audible warning signal by said warning means.

The system according to an aspect of the invention can moreover comprise said motor unit configured to control the position of the flush handle.

An aspect of the invention also covers an assembly comprising a flush handle for a motor vehicle door, and also a system according to an aspect of the invention, with the detection unit of said system housed in the flush handle.

An aspect of the invention also covers a motor vehicle with a door equipped with a flush handle, the vehicle moreover comprising a system according to an aspect of the invention, with the detection unit of said system housed in the flush handle.

An aspect of the invention also covers a method for controlling a flush handle mounted, during use, on a motor vehicle door, the method comprising:
transmission of a transmitted signal, of radio-frequency type, and reception of a return signal resulting from reflection of the transmitted signal by a target, the transmitted signal being a signal of pulsed type with a ratio of the bandwidth divided by the center frequency greater than or equal to 20% and/or whose spectral width is greater than 250 MHz;
generation of sampled data relating to the pulsed return signal;
for each of a plurality of successive time intervals, extraction of the sampled data situated in said time interval, and relating to sampling times for which the time difference (At) between transmission of a pulse of the transmitted signal and reception of a portion of a corresponding pulse of the return signal is lower than a first predetermined threshold;
a gesture detection performed using said extracted data, to detect a gesture indicating an intention to access the vehicle;
when such a gesture is detected, generation of an instruction to toggle the flush handle from a rest position to a gripping position, and sending of said instruction to a motor unit controlling a position of the flush handle between its rest position and its gripping position.

The method is performed within a system for controlling a flush handle mounted, during use, on a motor vehicle door, the system comprising:
a detection unit configured to transmit a signal called the “transmitted signal”, of radio-frequency type, and to receive a return signal resulting from reflection of the transmitted signal by a target; and
a control unit comprising at least one memory and at least one processor and configured to perform a gesture detection using the data from the detection unit and, when an intention to access the vehicle, associated with detection of a gesture, is detected, to generate an instruction to toggle from a rest position to a gripping position of the handle and to transmit said instruction to a motor unit configured to control a position of the flush handle.

### BRIEF DESCRIPTION OF THE DRAWINGS

Other features and advantages of aspects of the invention will become more clearly apparent upon reading the description that follows. This description is purely illustrative and should be read with reference to the appended drawings, in which:

FIG. 1A schematically illustrates a flush door handle of a motor vehicle, in a rest position;

FIG. 1B schematically illustrates a flush door handle of a motor vehicle, in a gripping position;

FIG. 2 schematically illustrates a system for controlling the toggling of a flush door handle of a motor vehicle from its rest position to its gripping position, according to a first embodiment of the invention;

FIG. 3 schematically illustrates sampled data relating to the return signal;

FIG. 4 schematically illustrates a system for controlling the toggling of a flush door handle of a motor vehicle from its rest position to its gripping position, according to a second embodiment of the invention.

### DETAILED DESCRIPTION OF AT LEAST ONE EMBODIMENT

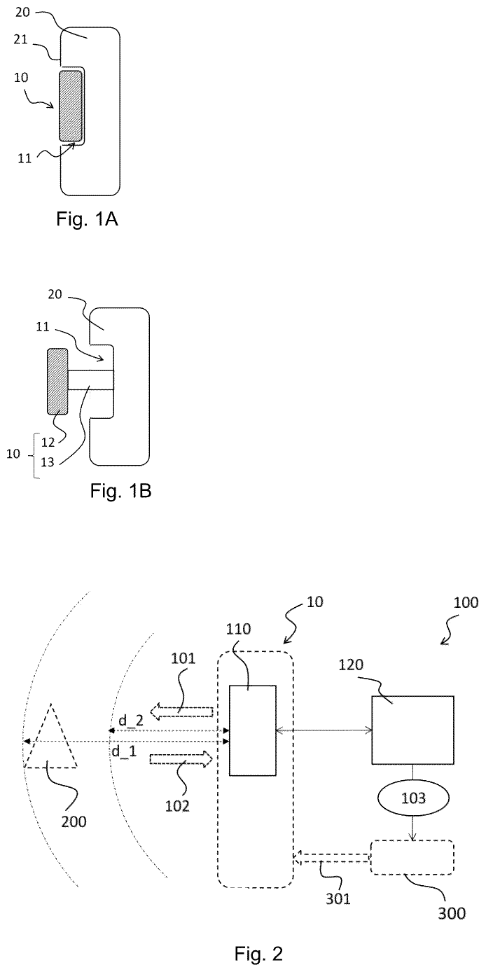

FIGS. 1A and 1B have been described in the introduction and show a flush door handle 10 of a motor vehicle in a rest position and a gripping position, respectively.

In the example of FIGS. 1A and 1B, the rest position is more particularly a retracted position, the gripping position is more particularly a deployed position, and the toggling from the rest position to the gripping position corresponds to a deployment of the handle.

First of all, an example of a system 100 for controlling a flush door handle 10 as illustrated in FIGS. 1A and 1B, according to a first embodiment of the invention, is described with reference to FIG. 2.

The handle is situated, during use, on the outside of the motor vehicle.

The elements relating to the system 100 are shown in solid lines, while the elements relating to the environment of said system are shown in dotted lines.

The system 100 comprises in particular:
a detection unit 110; and
a control unit 120.

During use, the detection unit 110 is in the handle 10. The control unit 120 can be arranged in the handle 10, for example integrated with the detection unit 110 within the same module, or arranged offset from the handle 10.

The detection unit 110 advantageously comprises (not shown specifically):
an electrical oscillator to generate an electrical signal capable of being converted into a radio-frequency signal,
at least one radio-frequency antenna for transmission and reception of radio-frequency signals,
at least one mixer to perform mixing of signals, and
at least one analog-to-digital converter to carry out a time sampling and convert an analog signal into a digital signal.

The detection unit 110 is configured to transmit a transmitted signal 101, of radio-frequency type, and to receive a return signal 102 resulting from reflection of the transmitted signal 101 by a target 200. Here, but in a non-limiting manner, the pulsed transmitted signal 101 and the pulsed return signal 102 are signals of pulsed type.

During use, the target 200 is advantageously formed by the hand of a user, approaching the door handle 10 and the detection unit 110.

The control unit 120 comprises at least one memory and at least one processor, which are not shown specifically.

It is configured to receive data from the detection unit 110, to analyze these data, to generate a deploy instruction 103 when an access intention of a user is detected, and to transmit said instruction 103 to a motor unit 300 controlling the position of the flush door handle 10.

The motor unit 300 preferably comprises an electric motor and also a control system for controlling the electric motor.

According to an aspect of the invention, the control unit 120 is configured in particular to perform a gesture detection using the data supplied by the detection unit 110, detection of a gesture indicating an access intention of a user.

In the general case, the motor unit 300 does not form part of the system 100 according to an aspect of the invention.

Advantageously, the detection unit 110 is configured to transmit a pulsed transmitted signal 101 for which a ratio of the bandwidth divided by the center frequency is greater than or equal to 20% and/or whose spectral width is greater than 250 MHz, preferably greater than or equal to 500 MHz. In other words, the pulsed transmitted signal 101 is an ultra-wideband, or UWB, radio-frequency signal.

This is because the use of a wideband signal makes it possible to extract a portion of the pulsed return signal that is associated, for each pulse of the pulsed return signal, with a desired time interval following the corresponding pulse of the pulsed transmitted signal. A portion of the pulsed return signal that is associated with a predetermined distance interval between the target 200 and the detection unit 110 housed in the handle 10 is thus selected. It is thus possible to detect a gesture occurring only within a desired distance interval from the handle 10. Said distance interval is delimited by a maximum distance from the handle, d_1, and a minimum distance from the handle, d_2, where d_2 can take the value zero.

In one advantageous variant, the control unit 120 is therefore configured to extract data relating to the pulsed return signal 102, and relating to sampling times for which the difference between a pulse of the pulsed return signal and the corresponding pulse of the pulsed transmitted signal is lower than a first predetermined threshold (fixing the distance d_1).

It is thus possible to detect only gestures that are sufficiently close to the handle 10, for which the probability that they actually reflect an intention to access the vehicle is high. Such a gesture is, for example, a gesture by which the user brings their hand into contact with the handle 10.

It is moreover possible to detect gestures far enough away from the handle 10 to allow the handle to be in the deployed position when the hand actually comes into direct physical contact therewith, given the time required for the handle 10 to move from the retracted position to the deployed position.

Preferably, the speed of deployment of the handle may be fixed or variable. In any event, the time required for the handle 10 to move from the retracted position to the deployed position is a known time. It is therefore possible to determine the distance at which to detect the gesture so that, given an expected speed of approach of the hand, the handle 10 ends its deployment movement at the moment at which the hand comes into contact therewith.

In one advantageous variant, the control unit 120 is configured to extract data relating to the pulsed return signal 102, and relating to sampling times for which the difference between a pulse of the pulsed return signal and the corresponding pulse of the pulsed transmitted signal is lower than a first predetermined threshold (fixing the distance d_1) and higher than a second predetermined threshold (fixing the distance d_2).

In one advantageous embodiment, the detection unit 110 is configured to generate sampled data relating to the pulsed return signal 102. Extraction then consists in extracting data associated with predetermined sampling times.

For example, the control unit 120 is configured to extract the data of the pulsed return signal 102 that are associated, for each pulse of the pulsed return signal, with one or more consecutive sampling pitches following transmission of the corresponding pulse of the pulsed transmitted signal 101. This corresponds to a time difference between transmission of a pulse of the pulsed transmitted signal 101 and reception of the corresponding pulse of the pulsed return signal 102 that is between two known values, depending on the sampling pitch. d_1 is advantageously between 150 cm and 10 cm, and d_2 is advantageously between 20 cm and 0 cm, with d_2<d_1.

For example, the control unit 120 is configured to extract the data of the pulsed return signal 102 that are associated, for each pulse of the pulsed return signal, with the second sampling pitch following transmission of the corresponding pulse of the pulsed transmitted signal 101. This corresponds to a time difference between transmission of a pulse of the pulsed transmitted signal 101 and reception of the corresponding pulse of the pulsed return signal 102 that is between one and two times the sampling pitch. For a sampling pitch of one nanosecond, this corresponds to d_1=30 cm and d_2=15 cm. In any event, d_1 is advantageously between 40 cm and 10 cm, and d_2 is advantageously between 20 cm and 0 cm, with d_2<d_1.

Advantageously, the detection unit 110 is more particularly configured to:
transmit the pulsed transmitted signal 101 toward the target 200 situated, during use, outside the vehicle;
receive the pulsed return signal 102 corresponding to a reflection (or backscatter) of the pulsed transmitted signal 101 by the target 200;
carry out a phase mixing and a quadrature mixing between the pulsed return signal 102 and the pulsed transmitted signal 101 or its carrier so as to generate data I(t) relating to a phase component of the pulsed return signal 102 and data Q(t) relating to a quadrature component of the pulsed return signal 102; and
carry out a time sampling upstream or downstream of the mixing, to supply sampled data relating to the pulsed return signal 102, here sampled data relating to the phase component I(t) and to the quadrature component Q(t) of the pulsed return signal 102.

The sampling preferably has a sampling pitch of between 0.8 ns and 2 ns, for example 1 ns. The sampling corresponds to supply of sampled data relating to the pulsed return signal 102, as mentioned above.

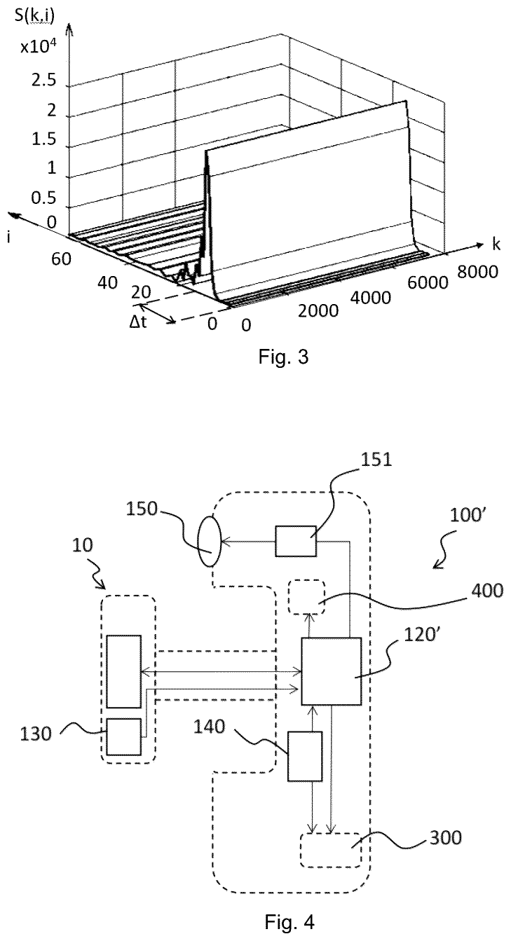

FIG. 3 schematically illustrates sampled data relating to the pulsed return signal 102. Said data are in matrix form. One axis of the matrix corresponds to a pulse index k of the pulsed transmitted signal 101. One axis of the matrix corresponds to an index i of a sampling time, the value of the index being reset to zero on each new pulse of the pulsed transmitted signal 101. A last axis of the matrix corresponds to the value S(k, i) taken by the sampled datum, each value being associated with one pulse index k of the pulsed transmitted signal and with one sampling time index i. In FIG. 3, a time difference At has been identified between the time of transmission of a pulse k of the pulsed transmitted signal 101 and the time of reception of the corresponding pulse of the pulsed return signal 102.

The values S(k, i) preferably correspond to the values of the phase component I(t) of the pulsed return signal 102 and to the values of the quadrature component Q(t) of the pulsed return signal 102. For example, there is a matrix for the values of I(t) and a matrix for the values of Q(t), or a single matrix for the values of the square root of I² (t) plus Q²(t), etc.

Advantageously, the detection unit 110 is configured to store the data S(k, i) and then to send them in packets to the control unit 120. They are sent at regular intervals ΔTⱼ.

The time intervals ΔTⱼ each have the same time width, and follow one another directly. This time width is advantageously between 0.8 ms and 1.2 ms, and for example equal to 1 ms.

The sampled data relating to the pulsed return signal, here the data S(k, i), are received by the control unit 120.

The control unit 120 then carries out an extraction of the data relating to sampling times for which the difference between the time of transmission of a pulse of the pulsed transmitted signal 101 and the time of reception of the corresponding pulse of the pulsed return signal 102 is lower than a first predetermined threshold. In other words, it is a question of extracting the data relating to a distance between the detection unit 110 and the target that is less than a first threshold distance d_1, or maximum distance from the handle.

In the example detailed above, the control unit 120 carries out an extraction of the data, separately over each time interval ΔTⱼ.

In one advantageous example, the sampling pitch is 1 ns. The control unit 120 carries out an extraction of the data relating to sampling times for which the difference between the time of transmission of a pulse of the pulsed transmitted signal 101 and the time of reception of the corresponding pulse of the pulsed return signal 102 is less than 2 ns, or twice the sampling pitch. This corresponds to a first threshold distance d_1 equal to 30 cm. Other values of d_1 are possible, depending in particular on the sampling pitch, and on the number of units of the sampling pitch chosen to fix the value of d_1, preferably 1 to 3 times the sampling pitch.

Advantageously, the control unit 120 then carries out a gesture detection using phase shift values of a phase shift between the pulsed return signal 102 and the pulsed transmitted signal 101, said phase shift values being obtained from the extracted data mentioned above.

Preferably, the control unit 120 computes one phase shift value per time interval ΔTj, said phase shift value φ(ΔTj) being obtained using the values S(k, i) mentioned above and with φ(t)=arctan(Q(t)/I(t)).

Preferably, the extracted data relating to various pulses of the pulsed transmitted signal, and potentially to various sampling times, are combined together in the form of an arithmetic mean for computing φ(ΔTj).

If necessary, gesture detection more particularly uses derivative values of the phase shift.

Here we have described how the control unit 120 controls deployment of the flush door handle in response to detection of a gesture close to said handle.

Advantageously, the control unit 120 is moreover capable of generating an instruction to toggle from the gripping position to the rest position, here a fold instruction, and of transmitting this instruction to the motor unit 300 controlling the position of the handle 10.

In a first embodiment, the control unit 120 is configured to generate and transmit the fold instruction after a predetermined time interval following sending of the deploy instruction. For this purpose, the control unit 120 in particular comprises a clock, which is not shown.

Alternatively, the fold instruction is generated, like the deploy instruction, in response to detection of a gesture. The choice between one or the other instruction, on the control unit 120, can simply depend on the current position of the handle, the aim of the command being to move the handle from one position to the other. Alternatively, the fold instruction is generated in response to detection of a predetermined gesture, in particular incorporating at least one change of direction.

A system 100′ for controlling deployment of a flush door handle 10, as illustrated in FIGS. 1A and 1B, according to a second embodiment of the invention, is now described with reference to FIG. 4.

The system of FIG. 4 will be described only in terms of its differences in relation to the system of FIG. 2. The system 100′ comprises a plurality of improvements in comparison with the system of FIG. 2. These various improvements can be combined all together within the same system, as illustrated in FIG. 4, or each combined in isolation with a system such as that of FIG. 2.

In the embodiment of FIG. 4, the control unit 120′ is moreover connected to an unlocking module for unlocking the door receiving the handle 10. In FIG. 4, this module is symbolized by the square bearing the reference 400. The control unit 120′ is then capable of generating an unlock instruction and of transmitting said instruction to the unlocking module 400.

The unlocking module 400 advantageously comprises a mechanical locking system, and also a unit for controlling said mechanical system.

In a first variant, which is not shown, the control unit 120′ is configured to transmit said instruction to the unlocking module 400 at the same time as it transmits the instruction to deploy the handle, or else after a predetermined time interval following transmission of the instruction to deploy the handle.

In a second variant as illustrated in FIG. 4, the system 100′ moreover comprises a presence sensor 130 configured to detect a presence in its immediate environment.

The presence sensor 130 is disposed, during use, in the handle 10, and more particularly in the gripping portion as mentioned in the introduction. It is, for example, a capacitive or inductive or piezoelectric or ultrasonic, etc., sensor capable of detecting direct physical contact or immediate proximity (typically less than one centimeter) between the user's hand and the handle.

The presence sensor 130 is configured to transmit detection data to the control unit 120′, and the control unit 120′ is configured to transmit the unlock instruction to the unlocking module 400 according to data supplied by the presence sensor 130. In particular, the control unit 120′ is configured to transmit the unlock instruction to the unlocking module 400 as soon as a presence in close proximity to the sensor 130 is detected using the presence sensor 130.

In advantageous variants, the presence sensor 130 serves as a redundant detection means to trigger sending of the instruction to deploy the handle if gesture detection has not worked. Additionally or alternatively, the presence sensor allows the control unit 120′ to be informed of the presence of the user's hand on the handle, in order to prevent an instruction to toggle to the rest position from being sent while the hand is in contact with the handle. One of the advantages is to prevent the hand from being pinched.

In other variants still, the module 400 is a locking and unlocking module for locking and unlocking the door receiving the handle 10. The control unit 120′ is then configured to transmit a lock instruction or an unlock instruction to the module 400. Said instruction can be synchronized with transmission of the instruction to deploy or fold the handle, or controlled by data supplied by at least one presence sensor situated in the handle.

In the embodiment of FIG. 4, the control unit 120′ is capable of generating a fold instruction and of transmitting said instruction to the motor unit 300 controlling the position of the flush door handle thanks to an electrical connection 301, and the system 100′ comprises a pinch detection unit 140.

The pinch detection unit 140 is capable of detecting the presence of an obstacle blocking folding of the handle 10, and of communicating this information to the control unit 120′. The control unit 120′ is configured to respond by generating and transmitting to the motor unit 300 an instruction intended to pause folding and/or deploy the handle 10.

The obstacle is, for example, a finger wedged between the vehicle and the gripping portion mentioned above. The pinch detection unit 140 thus provides safety to prevent a finger from being pinched when the handle 10 is folding.

The presence of a mechanical obstacle blocking folding of the handle 10 will result in an increase in the level of a control current sent to the input of the electric motor, the control system of the electric motor adapting the control current for the mechanical resistance encountered. The presence of an obstacle blocking folding of the handle 10 can therefore be detected by measuring the level of the control current sent to the input of the electric motor of the motor unit 300.

In the embodiment of FIG. 4, the system 100′ moreover comprises a warning means, here an indicator light 150, and also a unit 151 for controlling the indicator light.

The indicator light comprises, for example, at least one LED. During use, the indicator light 150 is visible to a user situated outside the vehicle and close to the handle 10. In particular, the indicator light 150 is situated, during use, on the outside of the vehicle, directly on the handle 10 or otherwise in close proximity thereto.

The unit 151 for controlling the indicator light is connected to the control unit 120′ and configured to toggle the indicator light from an off state to an on state when the control unit 120′ transmits an instruction to the motor unit 300, in particular an instruction to fold the handle 10.

The indicator light 150 and its control unit 151 thus provide safety to warn the user of folding of the handle 10 and thus limit a risk of pinching.

Alternatively, the warning means is configured to transmit a warning signal instead, or a combination of an audible warning signal and a luminous warning signal.

Aspects of the invention are not limited to the examples described above and covers in particular variants in which the rest position of the handle is a deployed position, the gripping position of the handle is a retracted position (housed inside a housing internal to the door, to free access to a cavity), and toggling from the rest position to the gripping position corresponds to a folding of the handle.

Also described is a system, not shown, for controlling a flush handle mounted, during use, on a motor vehicle door, the system comprising:
a detection unit; and
a control unit comprising at least one memory and at least one processor, configured to receive data from the detection unit, to analyze these data and generate an instruction to toggle from a rest position to a gripping position of the handle when an intention of a user to access the vehicle is detected, and to transmit said instruction to a motor unit configured to control a position of the flush door handle;
wherein:
   the detection unit is configured to transmit a transmitted signal, of optical type, and to receive a return signal resulting from reflection of the transmitted signal by a target; and
   the control unit is configured to perform a gesture detection using the data from the detection unit, detection of a gesture indicating the intention to access the vehicle.

The optical signal is advantageously an infrared signal. Gesture detection advantageously performs computations of time of flight and/or frequency shift related to the Doppler effect.

Such a system, based on transmission of an optical signal, can comprise one or more of each of the features of the system described above and based on transmission of a radio-frequency signal.

1. A system; for controlling a flush handle mounted, during use, on a motor vehicle door, the system comprising:
said flush handle equipped with a motor unit configured to control a position of the flush handle between a rest position and a gripping position;
a detection unit; and
a control unit; comprising at least one memory and at least one processor, configured to receive data from the detection unit, to analyze these data and generate an instruction to toggle from the rest position to the gripping position of said handle when an intention of a user to access the vehicle is detected, and to transmit said instruction to the motor unit;
characterized in that:
the detection unit is configured to transmit a transmitted signal, of radio-frequency type, and to receive a return signal resulting from reflection of the transmitted signal by a target, the transmitted signal being a signal of pulsed type for which a ratio of the bandwidth divided by the center frequency is greater than or equal to 20% and/or whose spectral width is greater than 250 MHz; and
the control unit is configured to perform a gesture detection using the data from the detection unit detection of a gesture indicating the intention to access the vehicle;
and wherein the detection unit and the control unit; are configured together to:
a) generate sampled data relating to the pulsed return signal and
b) for each of a plurality of successive time intervals, extract sampled data situated in said time interval, and relating to sampling times for which the time difference between transmission of a pulse of the transmitted signal and reception of a portion of a corresponding pulse of the return signal is lower than a first predetermined threshold.

2. The system as claimed in claim 1, wherein the detection unit and the control unit are configured together to then perform the following steps:
c) for each of said successive time intervals, and using the values extracted in step b), computing a phase shift value of a phase shift between the return signal and the transmitted signal; then
d) using the phase shift values to detect a gesture.

3. The system as claimed in claim 1, wherein said first predetermined threshold corresponds to a distance d_1 between the detection unit and the target, with d_1 being between 150 cm and 5 cm.

4. The system as claimed in claim 1, wherein step b/ carries out an extraction of the sampled data relating to sampling times for which the time difference between transmission of a pulse of the transmitted signal and reception of a portion of a corresponding pulse of the return signal is lower than a first predetermined threshold and higher than a second predetermined, non-zero threshold.

5. The system as claimed in claim 1, wherein the control unit is moreover connected to an unlocking module for unlocking the door receiving the flush handle, and the control unit is configured to generate an unlock instruction and to transmit said instruction to the unlocking module.

6. The system as claimed in claim 5, wherein the control unit is configured to transmit the unlock instruction after a predetermined time interval following transmission of the instruction to toggle from the rest position to the gripping position, the time interval possibly being zero.

7. The system as claimed in claim 5, further comprising a presence sensor configured to detect a presence in close proximity, and wherein the control unit is configured to transmit the unlock instruction according to data supplied by the presence sensor.

8. The system as claimed in claim 1, wherein the control unit is moreover capable of generating an instruction to toggle from the gripping position to the rest position, and of transmitting said instruction to the motor unit controlling the position of the flush handle.

9. The system as claimed in claim 8, further comprising a pinch detection unit capable of detecting the presence of an obstacle blocking toggling of the flush handle from one position to the other and of communicating this information to the control unit, and in that the control unit is configured to respond by generating and transmitting to the motor unit controlling the position of the flush handle an instruction intended to pause and/or reverse toggling of the flush handle from one position to the other.

10. The system as claimed in claim 1, further comprising:
a warning means configured to transmit a luminous and/or audible warning signal; and
a unit for controlling the warning means, connected to the control unit and configured to control transmission of a luminous and/or audible warning signal by said warning means.

11. The system as claimed in claim 1, wherein said motor unit configured to control the position of the flush handle.

12. An assembly comprising a flush handle for a motor vehicle door, and also a system as claimed in claim 1, with the detection unit of said system housed in the flush handle.

13. A motor vehicle with a door equipped with a flush handle, the vehicle moreover comprising a system as claimed in claim 1, with the detection unit of said system housed in the flush handle.

14. A method for controlling a flush handle mounted, during use, on a motor vehicle door, the method comprising:
transmission of a transmitted signal, of radio-frequency type, and reception of a return signal resulting from reflection of the transmitted signal by a target, the transmitted signal being a signal of pulsed type with a ratio of the bandwidth divided by the center frequency greater than or equal to 20% and/or whose spectral width is greater than 250 MHz;
generation of sampled data relating to the pulsed return signal;
for each of a plurality of successive time intervals, extraction of the sampled data situated in said time interval, and relating to sampling times for which the time difference between transmission of a pulse of the transmitted signal and reception of a portion of a corresponding pulse of the return signal is lower than a first predetermined threshold;
a gesture detection performed using said extracted data, to detect a gesture indicating an intention to access the vehicle;
when such a gesture is detected, generation of an instruction to toggle the flush handle from a rest position to a gripping position, and sending of said instruction to a motor unit controlling a position of the flush handle between its rest position and its gripping position.

15. The system as claimed in claim 2, wherein said first predetermined threshold corresponds to a distance d_1 between the detection unit and the target, with d_1 being between 150 cm and 5 cm.
